(19) United States
(12) Patent Application Publication
(10) Pub. No.: US 2014/0020844 A1
(43) Pub. Date: Jan. 23, 2014

(54) FILM PEELING APPARATUS

(71) Applicant: SAMSUNG DISPLAY CO., LTD., Yongin-City (KR)

(72) Inventors: Jeong-Hun WOO, Yongin-City (KR); Gyoo-Wan HAN, Yongin-City (KR); Il-Young JEONG, Yongin-City (KR)

(73) Assignee: SAMSUNG DISPLAY CO., LTD., Yongin-City (KR)

(21) Appl. No.: 13/669,344

(22) Filed: Nov. 5, 2012

(30) Foreign Application Priority Data
Jul. 18, 2012 (KR) 10-2012-0078392

(51) Int. Cl. B32B 38/10

(52) U.S. Cl. 156/580

(57) ABSTRACT

A film peeling apparatus for detaching a region of a film unit on a substrate and including: a tape supply unit configured to supply an adhesive tape onto the film unit; a plurality of pins arranged above the adhesive tape, vertically descendible toward the adhesive tape to attach a portion of the film unit to an adhesive surface of the adhesive tape, and sequentially vertically liftable after the portion of the film unit is attached to the adhesive surface of the adhesive tape; and a tape recovery unit configured to recover the adhesive tape having the portion of the film attached thereto, and apply a tension force to the adhesive tape after the portion of the film unit is adhered to the adhesive tape.

### CROSS-REFERENCE TO RELATED APPLICATION

This application claims priority to and the benefit of Korean Patent Application No. 10-2012-0078392, filed on Jul. 18, 2012 in the Korean Intellectual Property Office, the entire content of which is incorporated herein by reference.

### BACKGROUND

1. Field

Aspects of embodiments of the present invention relate to a film peeling apparatus.

2. Description of the Related Art

An organic light-emitting display apparatus includes an organic light-emitting device including a hole injection electrode, an electron injection electrode, and an organic light-emitting layer formed therebetween. The organic light-emitting display apparatus is a self-emissive type display apparatus that generates light when an energy state of excitons generated by the combination of holes injected from the hole injection electrode with electrons injected from the electron injection electrode in the organic light-emitting layer drops to a ground state from an excited state.

The organic light-emitting display apparatus does not require an additional light source, may be operated at a low voltage, may have a lightweight thin film structure, and has wide viewing angles, high contrast, and short response times, and thus, the organic light-emitting display apparatus is considered to be a next generation display.

However, in order to manufacture an organic light-emitting display apparatus, a plurality of film forming processes, film attaching processes, and film detaching processes may be performed. In particular, in a film detaching process, there is a need to develop a technique for readily detaching or peeling off a portion of a film from a desired region of the film without damaging surrounding regions of the film.

### SUMMARY

According to an aspect of embodiments of the present invention, a film peeling apparatus can readily detach a portion of a film located at an inner region of the film.

According to an embodiment of the present invention, a film peeling apparatus for detaching a region of a film unit on a substrate includes: a tape supply unit configured to supply an adhesive tape onto the film unit; a plurality of pins arranged above the adhesive tape, vertically descendible toward the adhesive tape to attach a portion of the film unit to an adhesive surface of the adhesive tape, and sequentially vertically liftable after the portion of the film unit is attached to the adhesive surface of the adhesive tape; and a tape recovery unit configured to recover the adhesive tape having the portion of the film attached thereto, and apply a tension force to the adhesive tape after the portion of the film unit is adhered to the adhesive tape.

The pins may be arranged in a row, and, after the portion of the film unit is attached to the adhesive tape, the pins may be sequentially vertically liftable from the pin located nearest to the tape recovery unit.

The portion of the film unit may be spaced apart from edges of the substrate.

The pins may be vertically liftable and vertically descendible independently from each other.

The tape recovery unit may include a reel that rotates clockwise or counterclockwise, and the reel may rotate synchronously with the movement of the pins that are sequentially vertically lifted.

The film peeling apparatus may further include an apparatus driving unit configured to vertically lift and vertically descend the film peeling apparatus relative to the substrate.

The apparatus driving unit may vertically lift the film peeling apparatus after the film unit is adhered to the adhesive tape.

The film peeling apparatus may further include a pressing surface to press regions surrounding the portion of the film unit to be detached by the pins.

The pressing surface may include a cushion unit.

The film peeling apparatus may further include a holder configured to fix the portion of the film unit on the adhesive tape such that the portion of the film unit is not detached from the adhesive tape.

The pins may be arranged along a length direction or a width direction of the film unit, and some of the pins may be selectively operated.

According to another aspect of the present invention, a film peeling apparatus for detaching a region of a film unit on a substrate includes: a tape supply unit comprising a first reel configured to supply an adhesive tape to the film unit; a plurality of pins arranged above the adhesive tape along a length of the adhesive tape, vertically descendible toward the adhesive tape to attach the film unit to an adhesive surface of the adhesive tape, and sequentially vertically liftable along a direction after the film unit is attached to the adhesive tape; and a tape recovery unit comprising a second reel configured to recover the adhesive tape having the film unit adhered thereto, and, after the film unit is adhered to the adhesive tape, the second reel is rotatable by an angle, and the first reel is stopped when the second reel rotates.

The film unit may be spaced apart from edges of the substrate.

The film peeling apparatus may further include a pressing surface above the film unit to press regions surrounding the film unit.

The pressing surface may include a cushion unit including rubber or silicon.

The film peeling apparatus may further include an actuator configured to vertically lift and descend the pins, and the pins may be independently vertically liftable and vertically descendible by the actuator.

The film peeling apparatus may further include a holder configured to fix the film unit to not be detached from the adhesive tape.

The film unit may have a plurality of grooves formed along outer sides of the film unit, and the grooves may have a depth less than a thickness of the film unit.

According to an embodiment of the present invention, a region of a film, such as a region located at an inner side of the film, may be readily peeled off or detached.

Additional aspects and/or advantages of the present invention are set forth in part in the description which follows and, in part, will be obvious from the description, or may be learned by practice of the invention.

### BRIEF DESCRIPTION OF THE DRAWINGS

The above and other features and aspects of the present invention will become more apparent by describing in detail some exemplary embodiments thereof with reference to the attached drawings in which:

FIG. 1A is a schematic perspective view of a film to be peeled by using a film peeling apparatus according to an embodiment of the present invention;

FIG. 1B is a schematic cross-sectional view of the film of FIG. 1A, taken along the line I-I;

FIG. 2 is a schematic perspective view of a film peeling apparatus according to an embodiment of the present invention;

FIG. 3 is a schematic perspective view of the film peeling apparatus of FIG. 2, shown disposed on a film;

FIG. 4A is a schematic perspective view of the film peeling apparatus of FIG. 3, showing an initial state of peeling a film unit of the film;

FIG. 4B is a schematic front view showing a state of pins of the film peeling apparatus of FIG. 4A and an initial state of the film unit;

FIG. 5 is a schematic perspective view showing the film unit mechanically fixed on an adhesive tape by a holder of the film peeling apparatus of FIG. 4A;

FIG. 6 is a schematic perspective view of the film peeling apparatus of FIG. 4A, showing detachment of a remaining region of the film unit from the film; and

FIGS. 7A, 7B, and 8 are schematic perspective views showing a film peeling apparatus disposed on a film unit according to other embodiments of the present invention.

### DETAILED DESCRIPTION

In the following detailed description, certain exemplary embodiments of the present invention are shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. The terminology used herein is for the purpose of describing particular embodiments of the present invention and is not intended to be limiting of the inventive concept. As used herein, singular forms are intended to include the plural forms as well, unless the context clearly indicates otherwise. It will further be understood that the terms “comprise” and/or “comprising,” when used in this specification, specify the presence of stated features, steps, tasks, operations, and/or components, but do not preclude the presence or addition of one or more other features, steps, tasks, operations, and/or components, and/or groups thereof. It will further be understood that, although the terms “first,” “second,” “third,” and the like may be used herein to describe various elements, these elements should not be limited by these terms, and the terms are used for the purpose of distinguishing an element from another element.

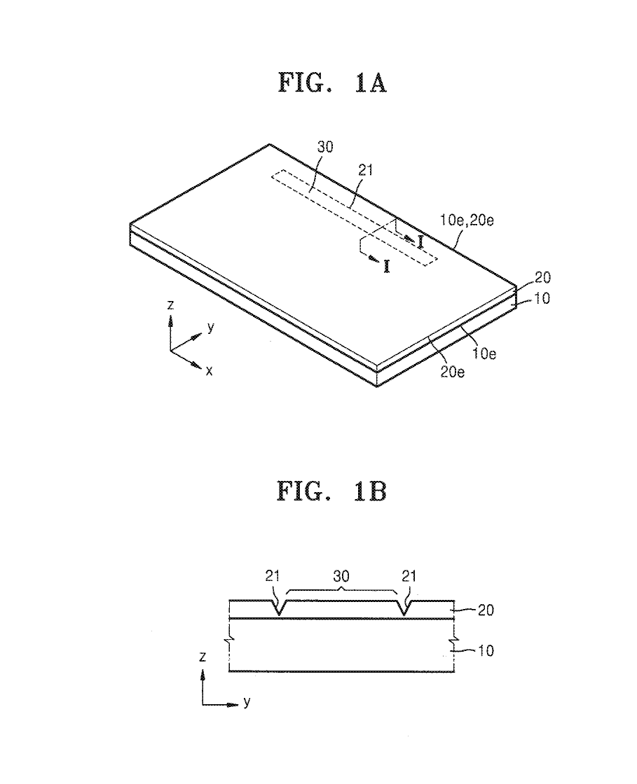

FIG. 1A is a schematic perspective view of a film 20 to be peeled partially by using a film peeling apparatus according to an embodiment of the present invention. FIG. 1B is a schematic cross-sectional view of the film 20, taken along the line I-I of FIG. 1A.

A film peeling apparatus according to an embodiment of the present invention is an apparatus for peeling a portion of the film 20, and may be disposed on a substrate 10. According to an embodiment of the present invention, a film unit 30 to be peeled off corresponds to a portion of a region of the film 20 to be peeled off by a film peeling apparatus according to an embodiment of the present invention.

In one embodiment, as depicted in FIG. 1B, grooves 21 (e.g., fine grooves) may be formed at an outer region of the film unit 30 so that the film unit 30 may be readily detached. The grooves 21 may be formed by using a member, such as a laser or a knife, and may have a depth smaller than a thickness of the film 20 in order to avoid damage of the substrate 10 when the grooves 21 are formed by the laser, knife, or other member.

As depicted in FIG. 1A, the film unit 30 is separated from edges 10e of the substrate 10 and/or edges 20e of the film 20. That is, the film unit 30 may be disposed at an inner region of the film 20.

If all of the film 20 formed on the substrate 10 needs to be detached, the film 20 may be readily detached from the substrate 10 by using a minute gap between the film 20 and the substrate 10 in a region corresponding to the edges 10e and 20e of the substrate 10 and the film 20. However, in an embodiment of the present invention, if the film unit 30 is a portion of a region of the film 20, and, in particular, if the film unit 30 is disposed at an inner region spaced apart from the edges 10e and 20e of the substrate 10 and the film 20, detachment of the film unit 30, which may otherwise be difficult, is facilitated by the film peeling apparatus according to an embodiment of the present invention.

The film peeling apparatus according to an embodiment of the present invention may readily detach a portion of the region of the film 20, and, in particular, a portion of the region of the film 20 located at an inner region of the film 20, that is, the film unit 30.

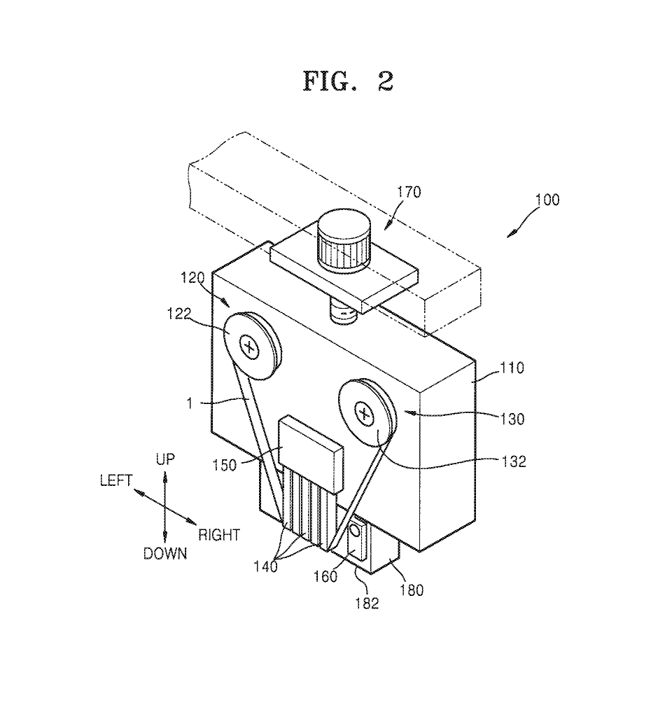

The configuration of a film peeling apparatus according to an embodiment of the present invention is described in further detail below with reference to FIG. 2.

FIG. 2 is a schematic perspective view of a film peeling apparatus 100 according to an embodiment of the present invention.

Referring to FIG. 2, the film peeling apparatus 100, in one embodiment, may include a body unit 110, a tape supply unit 120 disposed at a side of the body unit 110, a tape recovery unit 130, a plurality of pins 140 that vertically move up and down and are disposed above a flow of an adhesive tape 1 that moves from the tape supply unit 120 toward the tape recovery unit 130.

The tape supply unit 120 supplies the adhesive tape 1 and may include a first reel 122 on which the adhesive tape 1 is wound on an outer circumference thereof. In one embodiment, the adhesive tape 1 wound on the first reel 122 proceeds toward the tape recovery unit 130 as the first reel 122 rotates. A surface of the adhesive tape 1 is an adhesive surface on which an adhesive material is coated, and when the adhesive tape 1 is supplied, the adhesive surface of the adhesive tape 1 faces the film unit 30.

The tape recovery unit 130 recovers the adhesive tape 1, and may include a second reel 132 for winding the adhesive tape 1 to which the film unit 30 is attached. In one embodiment, the adhesive tape 1 to which the film unit 30 is attached proceeds due to the rotation of the second reel 132.

In one embodiment, the pins 140 are arranged in a row parallel to each other above a flow of the adhesive tape 1 that moves toward the tape recovery unit 130. The pins 140 may have a shape extending in a direction perpendicular or approximately perpendicular to the flow direction of the adhesive tape 1, and may vertically move up and down.

In one embodiment, the film peeling apparatus 100 includes an actuator 150 that is a power source for moving the pins 140 up and down by using electricity, hydraulic pressure, or compressed air, for example. The actuator 150, in one embodiment, may include a plurality of cylinders, and each of the pins 140 may be mechanically connected to a cylinder of the plurality of cylinders to individually move up and down through the reciprocal movement of the cylinder.

The pins 140 vertically move down to attach the adhesive tape 1 supplied from the tape supply unit 120 to the film unit 30. Since the pins 140 are disposed above the adhesive tape 1, when the pins 140 vertically move down, the adhesive surface of the adhesive tape 1 may be attached to the film unit 30. The pins 140 may move down concurrently (e.g., simultaneously) or sequentially.

When the adhesive tape 1 is attached to the film unit 30, the second reel 132 of the tape recovery unit 130 rotates counterclockwise (or clockwise). Tension is applied to the adhesive tape 1 by the rotation of the second reel 132. In one embodiment, the second reel 132 is disposed at a higher position than the pin 140 located at a rightmost side of the pins 140, and, as the second reel 132 rotates, the right side of the adhesive tape 1 is lifted. The force of lifting the adhesive tape 1 may peel a right edge of the tape that is attached to the adhesive tape 1 to be peeled off from the film 20. In one embodiment, when the second reel 132 rotates, the first reel 122 is in a fixed state without movement, that is, maintained in a stopped state.

When the second reel 132 rotates counterclockwise, the pins 140 move up. In one embodiment, the pins 140 are sequentially lifted. The pins 140, in one embodiment, are vertically lifted sequentially from the pin 140 nearest to the tape recovery unit 130 (e.g., the rightmost pin) toward the pin 140 farthest from the tape recovery unit 130 (e.g., the leftmost pin). In one embodiment, the pins 140 from the rightmost pin 140 to the leftmost pin 140 are sequentially vertically lifted. Accordingly, during an initial peeling of the film unit 30, the pins 140 disposed at the right side are vertically lifted and the pins 140 disposed at the left side press the adhesive tape 1 while contacting an upper surface of the adhesive tape 1.

In one embodiment, the grooves 21 formed along the outer sides of the film unit 30 have a depth less than the thickness of the film 20, and, thus, the film unit 30 is not in a state of being completely separated from the film 20. Accordingly, in order to completely separate the film unit 30 from the film 20, a force is applied to peel off the film unit 30 from the film 20. In particular, since the film unit 30 is not completely separated, at an initial stage of peeling, a force sufficient to peel off the film unit 30 from the film 20 is applied. That is, a force is applied onto an edge of the film unit 30 to peel off the film unit 30 from the film 20. If the pins 140 are not sequentially vertically lifted, but are instead concurrently (e.g., simultaneously) lifted or the pins 140 are not lifted, a force for peeling an edge of the film unit 30 from the film 20, that is, an initial force for separating the edge of the film unit 30 from the film 20 may not be sufficiently applied to the adhesive tape 1 to which the film unit 30 is attached. Accordingly, the film unit 30 may not be readily detached from the film 20.

According to one embodiment, at the initial stage of peeling the film unit 30, some pins 140 disposed at the right side are vertically lifted, and some pins 140 disposed at the left side press the adhesive tape 1 while contacting the upper surface of the adhesive tape 1. Therefore, a force that is generated by the rotation of the second reel 132 and, thus, is applied to the adhesive tape 1 to lift the adhesive tape 1 may be intensively applied to the right edge of the film unit 30. When the right edge of the film unit 30 is separated from the film 20, that is, after the initial stage of peeling, the film unit 30 may be separated from the film 20 with a relatively small force.

In one embodiment, the pins 140 are vertically lifted sequentially from the right side to the left side of the pins 140. However, the direction of lifting the pins 140 according to the present invention is not limited thereto. That is, the lifting direction may be any direction as long as the pins 140 are vertically lifted sequentially starting from the pin 140 nearest to the tape recovery unit 130.

In one embodiment, the film peeling apparatus 100 includes a holder 160 which may prevent or substantially prevent separation of the film unit 30 from the adhesive tape 1. In one embodiment, the film unit 30 may not be separated from the adhesive tape 1 by the adhesion force of the adhesive tape 1 and the fixing force of the holder 160. In particular, the holder 160 may prevent or substantially prevent separation of the film unit 30 from the adhesive tape 1 at an initial stage of peeling.

In one embodiment, the film peeling apparatus 100 includes an apparatus driving unit 170 that may vertically move the film peeling apparatus 100 up and down. For example, the apparatus driving unit 170 may vertically move the film peeling apparatus 100 downward to attach the film unit 30 to the adhesive tape 1, and, after the film unit 30 is attached to the adhesive tape 1, may vertically move the film peeling apparatus 100 upward.

In one embodiment, the film peeling apparatus 100 includes a compression unit 180 to press the film 20 around the film unit 30 when the film unit 30 is detached from the film 20 and, thus, may prevent or substantially prevent the film 20 around the film unit 30 from detaching from the substrate 10. The compression unit 180 may include a cushion unit (not shown) on a lower surface, that is, a pressing surface 182 of the compression unit 180, to avoid damage to an upper surface of the film 20. In one embodiment, the cushion unit on the pressing surface 182 may include rubber or silicone.

In one embodiment, the pressing surface 182 may be formed as the lower surface of the compression unit 180 by additionally including the compression unit 180. However, the present invention is not limited thereto. For example, according to another embodiment of the present invention, the body unit 110 may function as the compression unit 180. That is, the pressing surface 182 may be included as a lower surface of the body unit 110. In this case, when the film peeling apparatus 100 is vertically moved down by the apparatus driving unit 170, the pressing surface 182 included as the lower surface of the body unit 110 may apply a pressure (e.g., a predetermined pressure) to regions surrounding the film unit 30 while the pressing surface 182 contacts the regions surrounding the film unit 30.

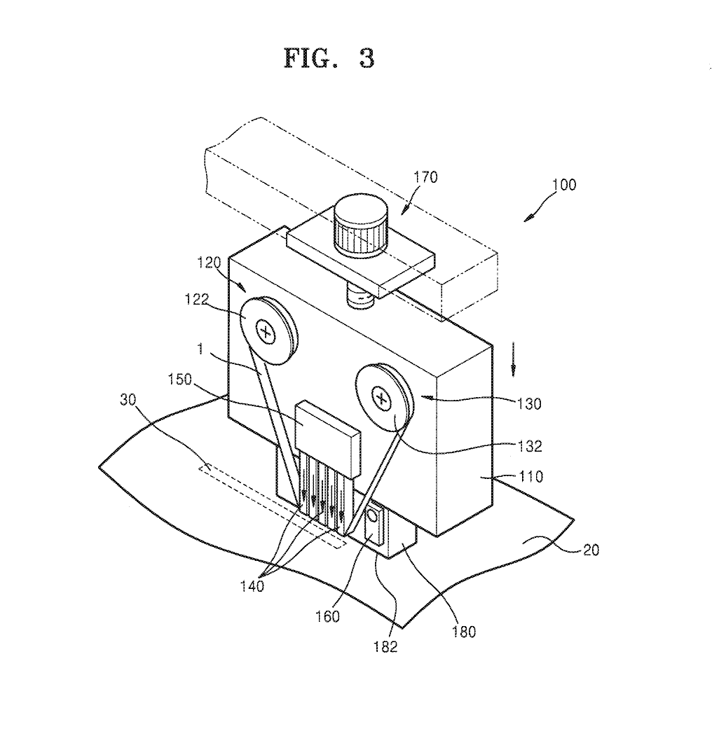

An operation of detaching the film unit 30 by using the film peeling apparatus 100 described with reference to FIG. 2 is described further below with reference to FIGS. 3 through 6.

FIG. 3 is a schematic perspective view of the film peeling apparatus 100, shown disposed on the film 20.

The film peeling apparatus 100 is disposed on the film 20 by being vertically moved downward by the operation of the apparatus driving unit 170. At this point, the pressing surface 182 contacts regions surrounding the film unit 30 on the upper surface of the film 20. An adhesive surface of the adhesive tape 1 is disposed on the upper surface of the film unit 30 when the film peeling apparatus 100 is vertically moved down, and the adhesive surface of the adhesive tape 1 adheres to the upper surface of the film unit 30 by the pins 140 that are disposed above a flow of the adhesive tape 1 vertically moving down.

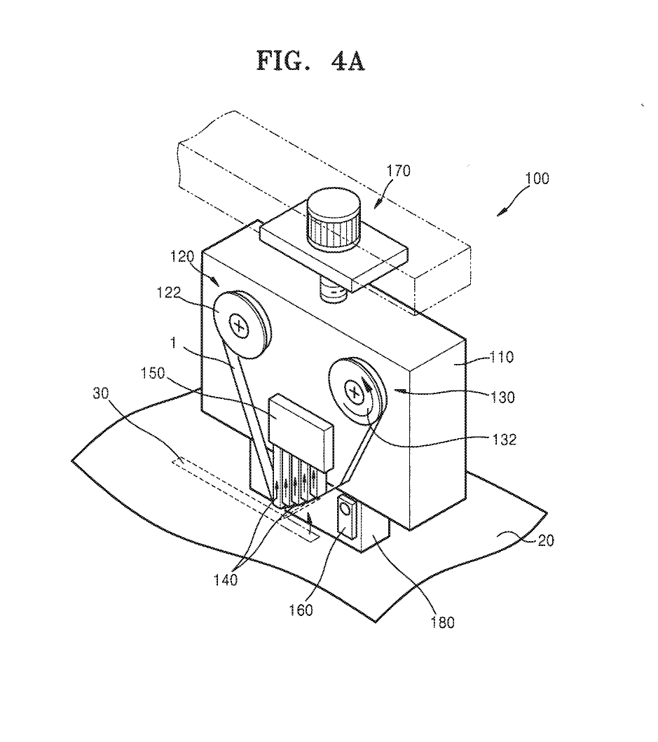

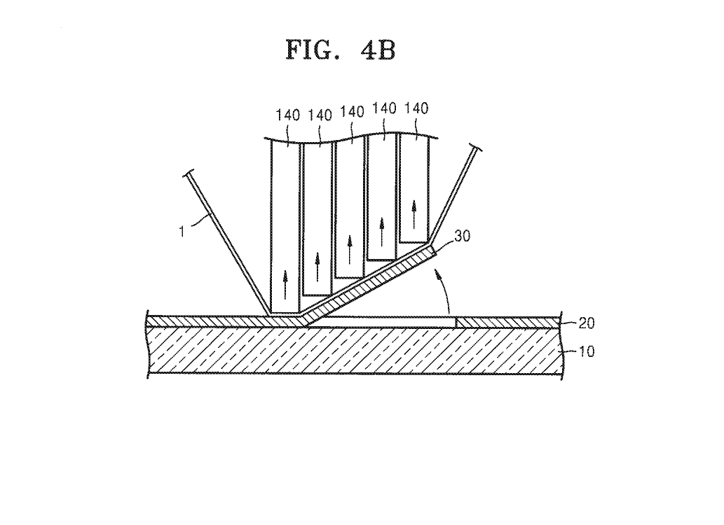

FIG. 4A is a schematic perspective view of the film peeling apparatus 100, showing an initial state of peeling the film unit 30. FIG. 4B is a schematic front view showing a state of the pins 140 and an initial state of the film unit 30.

Referring to FIGS. 4A and 4B, the second reel 132 rotates counterclockwise and the pins 140 are vertically lifted sequentially from the rightmost pin 140 to the leftmost pin 140. A force for lifting the adhesive tape 1 is applied to the adhesive tape 1 according to the counterclockwise rotation of the second reel 132 by an angle (e.g., a predetermined angle). At this point, since the pins 140 are vertically lifted from the rightmost pin 140 disposed nearest to the second reel 132, the force for lifting the adhesive tape 1 is concentrated on the right edge of the film unit 30, and, as a result, the right edge of the film unit 30 begins to detach from the film 20.

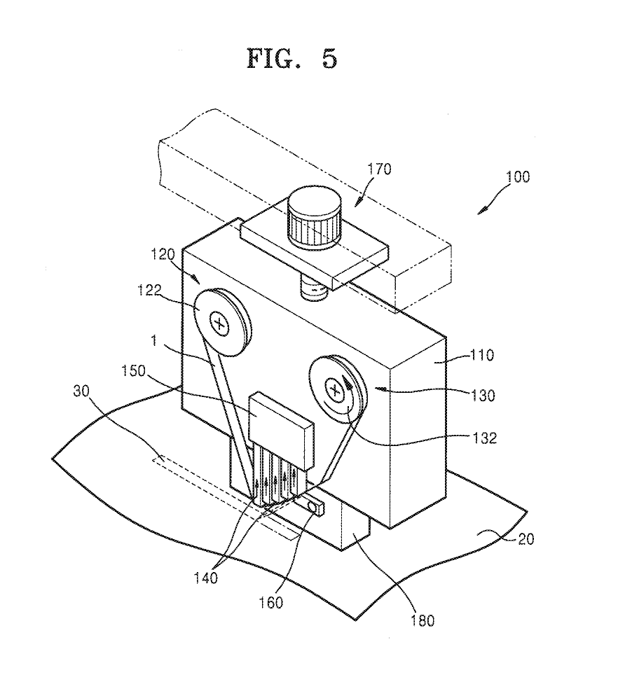

FIG. 5 is a schematic perspective view showing the film unit 30 mechanically fixed on the adhesive tape 1 by the holder 160.

Referring to FIG. 5, after an initial stage of peeling, the film unit 30 is mechanically fixed on the adhesive tape 1 by using the holder 160. In FIGS. 3 and 4, the film unit 30 is moved together with the adhesive tape 1 by the adhesive force of the adhesive tape 1. However, in FIG. 5, a mechanical fixing force is added to the film unit 30 by the holder 160, and, thus, the possibility of the film unit 30 detaching from the adhesive tape 1 is eliminated or reduced.

In FIG. 5, a case in which the compression unit 180 is formed at a side of the holder 160 is depicted. However, in embodiments of the present invention, the location and structure of the compression unit 180 are not specifically limited as long as the location and structure facilitate fixing the film unit 30 and the adhesive tape 1.

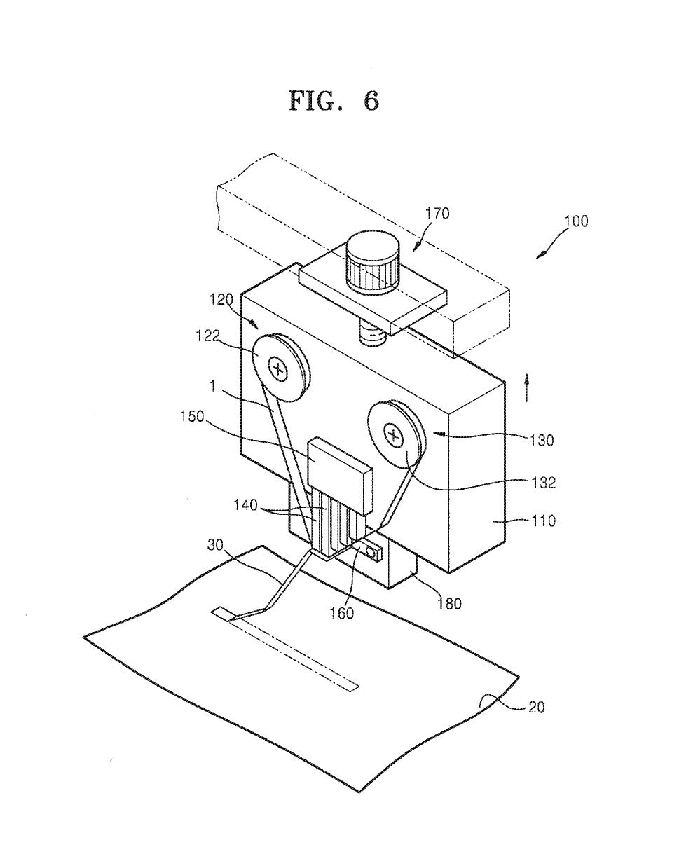

FIG. 6 is a schematic perspective view showing detachment of a remaining portion of the film unit 30 from the film 20 when the film peeling apparatus 100 is lifted.

Referring to FIG. 6, the film peeling apparatus 100, in one embodiment, is vertically lifted by driving the apparatus driving unit 170. As the film peeling apparatus 100 is vertically lifted, the film unit 30 may be completely detached from the film 20. When the film unit 30 is completely detached from the film 20, the adhesive tape 1 on which the film unit 30 is adhered is wound on an outer circumference of the second reel 132 while the first and second reels 122 and 132 rotate counterclockwise.

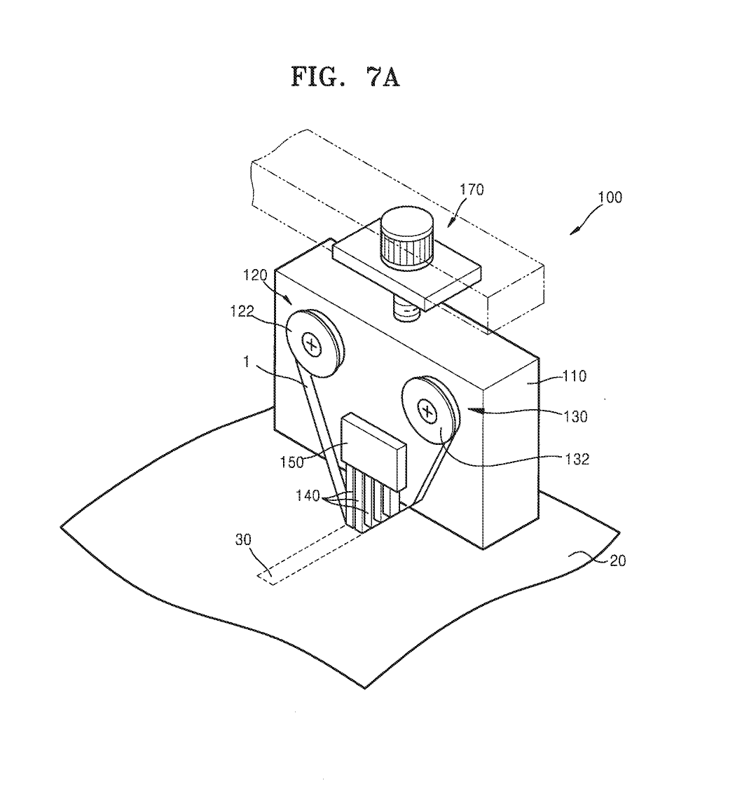

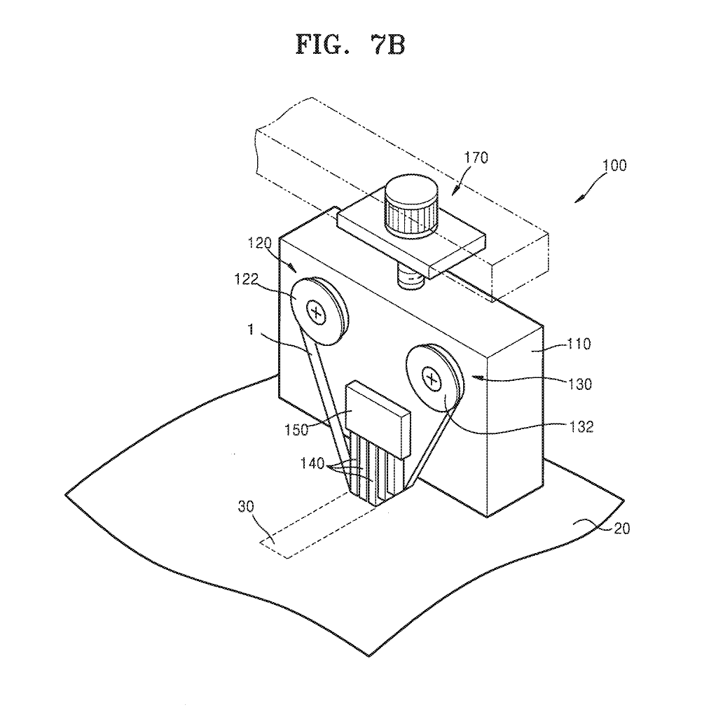

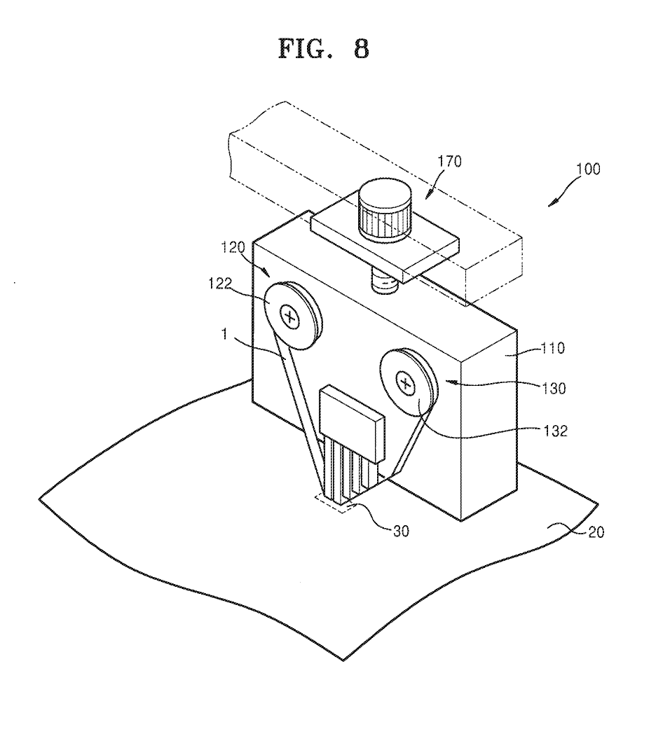

FIGS. 7A, 7B, and 8 are schematic perspective views showing a film peeling apparatus disposed on a film unit according to other embodiments of the present invention. In the operation of the film peeling apparatus 100 described with reference to FIGS. 3 through 6, a case in which the pins 140 are disposed in a length direction of the film unit 30 is described above. However, in FIGS. 7A, 7B, and 8, the pins 140 are disposed in a width direction of the film unit 30.

As depicted in FIGS. 7A, 7B, and 8, the pins 140 may be disposed in the width direction of the film unit 30. In one embodiment, the configurations and operations of the film peeling apparatuses 100 shown in FIGS. 7A, 7B, and 8 are the same as the configuration and operation of the film peeling apparatus 100 described with reference to FIGS. 2 through 6. However, the film peeling apparatus 100 according to one embodiment, in which the pins 140 are arranged in a width direction of the film unit 30, may be applied to detach the film unit 30 with a relatively low force. That is, when the film unit 30 has a width smaller than a length, and the pins 140 are arranged as depicted in FIGS. 7A and 7B, a force applied to an edge of the film unit 30 may be relatively small.

When the film unit 30 has a width smaller than a length, only some of the pins 140 may be used. Since the pins 140 are independently driven, the remaining pins 140 may not be moved while lifting by the actuator 150.

According to another embodiment of the present invention, as depicted in FIG. 8, if the film unit 30 has a relatively small area, the film unit 30 may be detached from the film 20 by using only some of the pins 140. In one embodiment, a configuration and operation of the film peeling apparatus 100 shown in FIG. 8 is the same as the configuration and operation of the film peeling apparatus 100 described above with reference to FIGS. 2 through 6.

The film peeling apparatuses described above according to embodiments of the present invention may be used not only for manufacturing an organic light-emitting display apparatus but also for other film peeling application, such as in manufacturing solar cells, semiconductor devices, or liquid crystal display apparatuses, for example.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A film peeling apparatus for detaching a region of a film unit on a substrate, the film peeling apparatus comprising:
a tape supply unit configured to supply an adhesive tape onto the film unit;
a plurality of pins arranged above the adhesive tape, vertically descendible toward the adhesive tape to attach a portion of the film unit to an adhesive surface of the adhesive tape, and sequentially vertically liftable after the portion of the film unit is attached to the adhesive surface of the adhesive tape; and
a tape recovery unit configured to recover the adhesive tape having the portion of the film attached thereto, and apply a tension force to the adhesive tape after the portion of the film unit is adhered to the adhesive tape.

2. The film peeling apparatus of claim 1, wherein the pins are arranged in a row, and, after the portion of the film unit is attached to the adhesive tape, the pins are sequentially vertically liftable from the pin located nearest to the tape recovery unit.

3. The film peeling apparatus of claim 1, wherein the portion of the film unit is spaced apart from edges of the substrate.

4. The film peeling apparatus of claim 1, wherein the pins are vertically liftable and vertically descendible independently from each other.

5. The film peeling apparatus of claim 1, wherein the tape recovery unit comprises a reel that rotates clockwise or counterclockwise, and the reel rotates synchronously with the movement of the pins that are sequentially vertically lifted.

6. The film peeling apparatus of claim 1, further comprising an apparatus driving unit configured to vertically lift and vertically descend the film peeling apparatus relative to the substrate.

7. The film peeling apparatus of claim 6, wherein the apparatus driving unit vertically lifts the film peeling apparatus after the film unit is adhered to the adhesive tape.

8. The film peeling apparatus of claim 1, further comprising a pressing surface to press regions surrounding the portion of the film unit to be detached by the pins.

9. The film peeling apparatus of claim 8, wherein the pressing surface comprises a cushion unit.

10. The film peeling apparatus of claim 1, further comprising a holder configured to fix the portion of the film unit on the adhesive tape such that the portion of the film unit is not detached from the adhesive tape.

11. The film peeling apparatus of claim 1, wherein the pins are arranged along a length direction or a width direction of the film unit, and some of the pins are selectively operated.

12. A film peeling apparatus for detaching a region of a film unit on a substrate, the film peeling apparatus comprising:
a tape supply unit comprising a first reel configured to supply an adhesive tape to the film unit;
a plurality of pins arranged above the adhesive tape along a length of the adhesive tape, vertically descendible toward the adhesive tape to attach the film unit to an adhesive surface of the adhesive tape, and sequentially vertically liftable along a direction after the film unit is attached to the adhesive tape; and
a tape recovery unit comprising a second reel configured to recover the adhesive tape having the film unit adhered thereto,
wherein, after the film unit is adhered to the adhesive tape, the second reel is rotatable by an angle, and the first reel is stopped when the second reel rotates.

13. The film peeling apparatus of claim 12, wherein the film unit is spaced apart from edges of the substrate.

14. The film peeling apparatus of claim 12, further comprising a pressing surface above the film unit to press regions surrounding the film unit.

15. The film peeling apparatus of claim 14, wherein the pressing surface comprises a cushion unit comprising rubber or silicone.

16. The film peeling apparatus of claim 12, further comprising an actuator configured to vertically lift and descend the pins, wherein the pins are independently vertically liftable and vertically descendible by the actuator.

17. The film peeling apparatus of claim 12, further comprising a holder configured to fix the film unit to not be detached from the adhesive tape.

18. The film peeling apparatus of claim 12, wherein the film unit has a plurality of grooves formed along outer sides of the film unit, wherein the grooves have a depth less than a thickness of the film unit.
